(19) United States
(12) Patent Application Publication
(10) Pub. No.: US 2004/0021918 A1
(43) Pub. Date: Feb. 5, 2004

(54) 3D Display

(76) Inventors: Colin. D Cameron, Worcestershire (GB); Christopher W Slinger, Worcesteshire (GB)

Correspondence Address: NIXON & VANDERHYE, PC, 1100 N GLEBE ROAD, 8TH FLOOR, ARLINGTON, VA, 22201-4714, US

(21) Appl. No.: 10/415,966

(22) PCT Filed: Nov. 6, 2001
(86) PCT No.: PCT/GB01/04893

(51) Int. Cl. G02B 5/32

(52) U.S. Cl. 359/15

(57) ABSTRACT

A procedure for displaying Diffraction Specific (DS) Computer Generated Holograms (CGH) includes the provision of a novel diffraction table (DT) modified so as to store a complete decoded fringe for each point capable of being projected into the image volume. When generating a DS CGH the diffraction table is produced that holds data relating to the image to be projected. The prior art stores in this diffraction table a set of hogel vectors that are used to select a set of basis fringes relating to each point to be displayed on the CGH. This means that each basis fringe corresponding to a particular hogel vector must be accumulated together with all the others before a complete fringe is produced. The pre-computation of the fringes as per the current invention singificantly reduces the online processing requirements of producing an image, as the new DT can be produced offline with no knowledge of the image to be displayed.

This invention relates to improvements to three-dimensional (3D) displays, and their associated image generation means. More specifically, it relates to a display system and method having a reduced computation time and power needed when generating image data using a diffraction specific computer generated holographic (CGH) algorithm.

Introduction

Holographic displays can be seen as being potentially the best means of generating a realistic 3D image, as they provide depth cues not available in ordinary two dimensional displays or many other types of 3D display. The accommodation depth cue, for example, is a cue that the brain receives when a viewer's eye focuses at different distances and is important up to about 3 meters in distance. This is, of course a cue that is used when looking at real objects, but of the 3D display technologies currently available, only true holograms provide 3D images upon which the eye can use its accommodation ability. It is a desire to be able to produce reconfigurable holographic displays electronically, such that an image can be generated from computer held data. This gives flexibility to produce holographic images of existing objects or non-existent objects without needing to go through the time consuming and expensive steps normally associated with their production.

Unfortunately, producing such an image electronically is extremely challenging. Methods exist, however, for just such generation, but they currently require a large amount of computing time, and specialised display hardware.

One such method of computing a CGH is to use what is known as the Diffraction Specific (DS) algorithm. A DS CGH is a true CGH (as opposed to a holographic stereogram variant) but has a lower computational load than Interference Based true CGH algorithms. The reason for this is that the DS algorithm is currently the most effective in terms of controlling the information content of CGH and avoiding unnecessary image resolution detail that cannot be seen by the human eye.

A key concept of the DS algorithm is the quantisation of the CGH in both spatial and spectral domains. This allows control of the amount of data, or the information content of the CGH, which in turn reduces the computational load. The CGH is divided up into a plurality of areas, known as hogels, and each hogel has a plurality of pixels contained within it. The frequency spectrum of each hogel is quantised such that a hogel has a plurality of frequency elements known as hogel vector elements.

The CGHs themselves are displayed on a panel capable of being programmed to diffract light in a controlled manner. This panel is usually a spatial light modulator. Note that the term “diffraction panel” is used to describe this panel in this specification before diffraction information is written to it, although once the diffraction panel is written with diffraction information, it can be interchangeably termed a CGH.

The 3D-image volume is made up by the diffraction of light from the complete set of hogels. The diffraction process sends light from one of the hogels in a number of discrete directions, according to which hogel vector elements are selected, as described below.

A given image must have the correct hogel vector elements selected in the appropriate hogels in order to display properly the image components. A diffraction table allows this selection to be done correctly. The diffraction table maps locations in the image volume to a given hogel, and to the required hogel vector elements of that hogel. These locations, or nodes, are selected according to the required resolution of the 3D image. More nodes will give a better resolution, but will require more computing power to generate the display. Having control of the nodes therefore allows image quality to be traded for reduced processing time. In the prior art the hogel vector selects which basis fringes are required by a given hogel in order to construct the 3D-image information.

The selection of the required diffraction table entries is computed from data based on the 3D image or scene to be displayed. A geometric representation of the image is stored in the computer system. The geometric information is rendered using standard computer graphics techniques in which the depth map is also stored. The rendering frustum is calculated from the optical parameters of the CGH replay system. The rendered image and the depth map are used to define, in three dimensions, what parts of the whole 3D image will be visible to a particular hogel. These parts define which diffraction table entries should be used to compute the hogel vector.

Finally, to produce the full CGH, the hogel vectors are decoded using basis fringes. A basis fringe has the same spatial extent as the hogel it is associated with and has a finite frequency content centred on a given hogel vector element. Basis fringes are pre-computed and are object geometry independent. Their computation is based on a complex set of constraints such that the weighted linear accumulation of the entire set of basis fringes (one for each hogel vector element) results in a complete hogel with a pseudo continuous spectrum. This process is repeated for each hogel that comprises the CGH.

More details of this procedure can be found in refs. 1, 2 and 3.

There are problems with this method however. The processing effort required in carrying out the above steps is too great for all but small images to be produced. Even though the DS algorithm is the most efficient one used for generation of a CGH, it still takes a significant amount of time on a high end computer system to do the processing required for each image.

### STATEMENT OF INVENTION

According to the present invention there is provided a computer generated hologram display system comprising at least a light diffraction plane notionally divided into a plurality of hogels, an image volume space and image calculation means, wherein the image calculation means incorporates a diffraction table that stores, for each hogel, fringe information that can be written to the hogel that directly reconstructs a wavefront to be projected towards the image volume space to create an image point.

Thus where the prior art stored in the diffraction table a set of hogel vector elements that require decoding with basis fringes before being written to the light diffraction plane, the current invention stores in the diffraction table a fully decoded fringe that can be directly written to the diffraction plane. This results in much faster generation of the hologram, as the decoding process of the prior art needs to be done on-line, i.e. has to be done for each different object geometry during the actual CGH calculation.

The current invention generates the diffraction table offline, and no knowledge of the object to be displayed is needed in its generation.

The invention removes the need for basis fringes altogether, as the diffraction table now stores the fully decoded hogel fringes in the form in which they are written to the light diffracting panel. Note that in this specification, a fully decoded fringe is known as a hogel fringe.

The step of decoding the hogel vector is no longer necessary with the current invention. The prior art required the hogel vectors to be multiplied by the pre-computed basis fringes to generate the final hologram data. The current invention provides for the decoding process to be replaced with a look-up stage that merely takes the appropriate parts of the diffraction table containing the hogel fringe data for each hogel.

This look-up stage requires knowledge of the geometry data for whatever object is desired to be displayed. Optical replay geometry is used to calculate a series of frustums in 3D space for each hogel. Rendering of the frustums provides 2D images with depth information, and is used to calculate which image volume points a given hogel must create. The hogel fringes stored in the DT that correspond to those points that are so required are used to populate the hogel. This is done by accumulating the diffraction table entries for each image volume point into the final accumulated hogel fringe.

In effect, during the offline part of the processing, the image volume is sampled in space at some suitable resolution, taking into account the limitations of the resolution of the human eye and the requirements of the application to which the display is to be put. Thus the diffraction table of the current invention stores information on every point in the image volume, not just the ones that make up the image to be displayed. When it is required for the system to display a given object, the image details of the object are used, as described above, to look up the hogel fringe information relating to each point on the object surface.

According to another aspect of the invention there is provided a method for displaying a computer generated hologram display system comprising at least a light diffraction plane notionally divided into a plurality of hogels, an image volume space and image calculation means, wherein the method comprises the steps of incorporating a diffraction table with the image calculation means and storing in the diffraction table pre-calculated fringe information for each hogel, and writing the fringe information to each hogel that directly reconstructs a wavefront to be projected towards the image volume space to create an image point.

The current invention may be implemented on any suitable computer system. In particular, this computer system may be integrated into a single computer, or may contain distributed elements that are connected together using a network.

The method of the current invention may be implemented as a computer program running on a computer system. The program may be stored on a carrier, such as a hard disk system, floppy disk system, or other suitable carrier. The computer system may be integrated into a single computer, or may contain distributed elements that are connected together across a network.

### DETAILED DESCRIPTION AND DRAWINGS

The current invention will now be described in detail, by way of example only, with reference to the following diagrams, in which

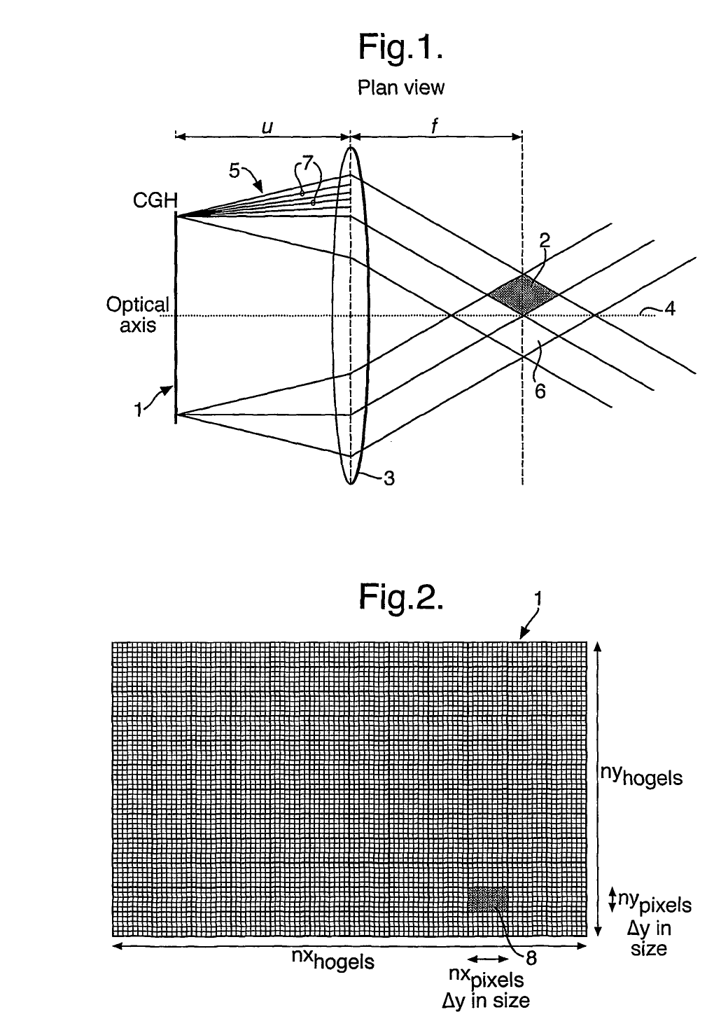

FIG. 1 illustrates in diagrammatic form the geometry of the CGH replay optics.

FIG. 2 illustrates in diagrammatic form a CGH showing the division of the area into hogels.

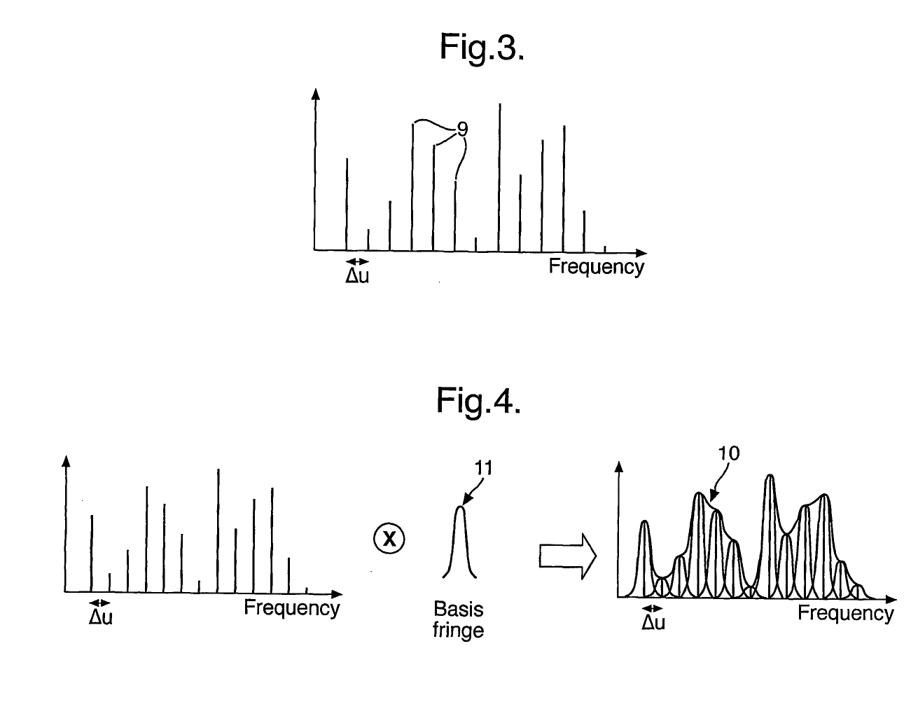

FIG. 3 illustrates in diagrammatic form a typical hogel vector.

FIG. 4 illustrates in diagrammatic form the hogel vector decoding process of the prior art.

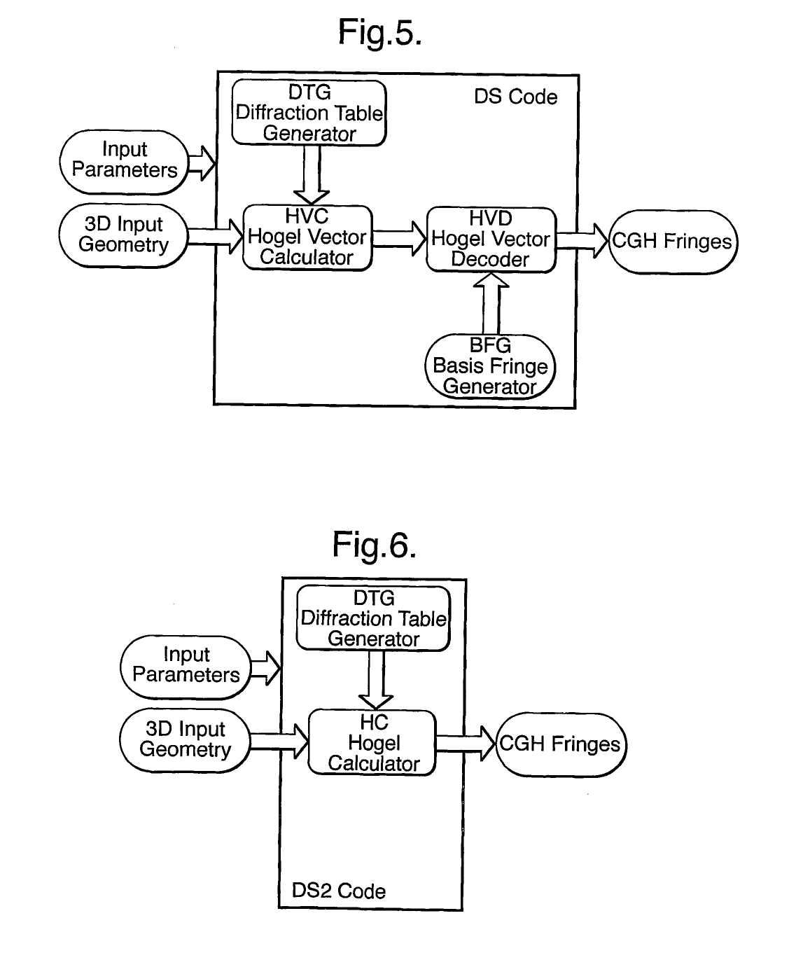

FIG. 5 illustrates in block diagrammatic form a logical breakdown of the steps required to compute a Diffraction Specific CGH as used in the prior art.

FIG. 6 illustrates in block diagrammatic form the reduced steps of the current invention

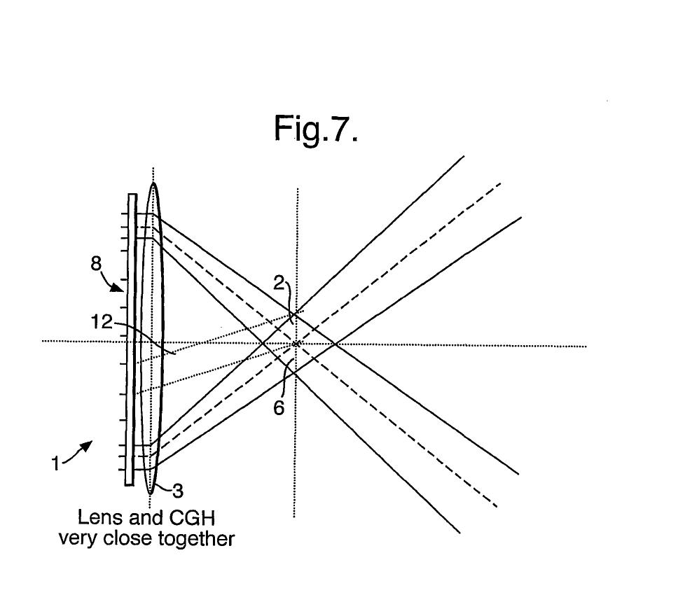

FIG. 7 illustrates in diagrammatic form the setup of the replay optics of the current invention, and shows for a single hogel the frustum that is rendered.

FIG. 1 illustrates the replay optics of a general CGH system, including a system capable of implementing the current invention. The diffraction panel 1 is shown transmitting a set of plane waves 7, encompassed by a diffraction cone 5 through a Fourier lens 3, where the waves 7 get refracted towards an image volume 2. It can be seen that the extent of diffraction of the plane waves, given by the cone 5 defines the size of the image volume 2. As the diffracted waves 7 radiate symmetrically from the diffraction panel 1, a conjugate image volume 6 is also formed adjacent the image volume 2. FIG. 1 only shows plane waves 7 radiating from one area of the panel 1, but of course in practice, each hogel on the panel 1 will be radiating such waves. If the diffraction panel 1 is written correctly with appropriate fringe data for a given hologram, a viewer in the viewing zone 4 will see a true 3D image in the image volume 2, and the image conjugate in the volume 6. In practice, the conjugate image 6 is usually masked out.

The distance of separation between the Fourier lens 3 and the diffraction panel 1 is kept as short as possible to simplify the processing. The steps involved in calculating the hogel vector components as shown below assume that this distance is zero.

FIG. 2 shows the spatial quantisation of the diffraction panel 1 into a 2D array of hogels. Each hogel (for example 8) is shown having a plurality of pixels in two dimensions. Therefore, a diffraction panel 1 so divided would be suitable for implementing a full parallax (FP) system. The number of pixels shown present in each of the hogels (for example 8) is shown figuratively only. In practice there would be approximately 2000 to 4000 pixels in each hogel dimension. In a Horizontal Parallax Only (HPO) system, each hogel would have only one pixel in the vertical dimension, but approximately 2000 to 4000 in the horizontal dimension.

The current implementation is restricted to a HPO system, to ease computing requirements. A HPO system is calculated to provide a fringe pattern that diffracts only in a single dimension—usually the horizontal dimension. This allows reduced pixel counts, which are hence faster to calculate. Anamorphic optics can also be used in the replay of such a hologram.

FIG. 3 shows the spectral elements 9 of a typical hogel vector that is stored for each hogel. A diffraction table of the prior art holds such a hogel vector for each hogel in the system. This is the method of the prior art. Each component of the vector represents a spatial frequency present in the final decoded fringe to be written to the hogel in question.

FIG. 4 shows how the prior art converts the hogel vector of FIG. 3 into a form having a continuous spectrum 10. This is the spectrum of the final decoded fringe that is written to the light diffracting panel 1. Each element of the vector, similar to that shown in FIG. 3, is multiplied with a basis fringe 11 pre-computed for that spectral element, to produce a smooth output spectrum as shown on the right in FIG. 4. This all takes a significant amount of processing, resulting in the need for either more computing power, or longer image processing times.

FIG. 5 shows the stages of computation necessary in the prior art to produce fringe data for a DS CGH. Data relating to the object to be displayed, as well as other input parameters such as the required resolution, hogel parameters, wavelength of light and optical replay system parameters are inputs to the code. The diffraction table generator holds a pre-computed set of hogel vector elements relating the hogels to points in image volume space. Appropriate hogel vector elements are selected by the hogel vector calculator, according to which points are required to make up the complete object. These points are given by the 3D geometry as discussed elsewhere in this specification. The hogel vectors that are chosen by the hogel vector calculator are then input to the hogel vector decoder, which generates a decoded fringe spectrum by selecting and accumulating the appropriate basis fringes for each hogel vector element. The resulting decoded fringe forms a part of the final CGH and is displayed on the diffraction panel.

FIG. 6 show the stages of computation necessary with the current invention. The input information is similar as before, but there are fewer stages of computation necessary to produce the CGH fringes. The current invention has a diffraction table that holds, instead of hogel vector elements in the form of the prior art, complete, decoded hogel fringes. These are selected by the hogel calculator according to which points are required for a given hogel, in order for that hogel to construct points in the image volume that are visible to a viewer observing the CGH at an angle for which diffracted light from the hogel enters the observers eye. The result of this is a fully decoded hogel fringe that is ready to be written to the appropriate hogel location on the diffraction panel.

Note that the wavelength of the light used to read the resultant hologram is a parameter to be considered when calculating the decoded hogel fringes that are stored in the diffraction table. Although current embodiments are based on only a single wavelength being used, that wavelength may be anything suitable for a given application. Off-line precalculation of the diffraction table is all that is necessary if the wavelength needs to be changed. The diffraction table can be enlarged to include decoded hogel fringes that are calculated for more than one wavelength simultaneously. In this way, the system is able to quickly change between different readout wavelengths, or to create holograms for multiple wavelength readout.

FIG. 7 shows how the geometry gives rise to a frustum 12 for each hogel. The rendered frustum 12 then results in a 2D image of the 3D object as seen from the particular hogel in question, along with information recording the depth of each point in the frustum. This work is done by the hogel calculator shown in FIG. 6, using a routine known as the Multiple Point Renderer.

The hogel fringes stored in the diffraction table of the current invention are calculated as follows.

For a given optical geometry and CGH the allowable image volume is sampled in space such that resolution of the sampled points is above the resolution for typical viewing distance. These points are used to construct a Diffraction Table (DT) and the points are referred to as Diffraction Table Points (DTP's). The wavefront of a DTP at a hogel is given, for an idealised situation, by equation (1), z=0 is assumed, see [2].

$$\begin{matrix}a ( x ) = \frac{{a}_{p}}{r} exp [ ⅈ k r ] exp [ ⅈ k ( f - \sqrt{{x}^{2} + {f}^{2}} ) ] \\ where r = \sqrt{{( x - {x}_{p} )}^{2} + {( z - {z}_{p} )}^{2}}\end{matrix} \qquad ( 1 )$$

aₚ is the point amplitude

xₚ, zₚ is position of point p

however in general the wavefront will be more complex, and would be determined in practice by, for example, Optical Ray Tracing

We then optionally sample the wavefront through the replay optical components at each hogel pixel position, or compute the hogel vector before then decoding it in advance. This can be done in a number of ways. The most computationally efficient method is to Fourier transform the real component of the calculated wavefront. As long as the developer is careful to avoid sampling artefacts sometimes associated with Fourier transforms this can give directly the hogel vector.

Alternative strategies can also be applied. These include using Fourier series for each hogel vector component, m, and numerically integrating the Fourier component over the hogel extent:

$$h {v}_{m} = {\int }_{x min}^{x max} exp [ \frac{- I m2 π x}{period} ] a ( x , z ) ⅆ x \qquad ( 2 )$$

where xmin and xmax define the hogel boundaries.

$$\begin{matrix}So , \int exp [ - ⅈω x ] \frac{{a}_{p}}{r ( x )} exp [ ⅈ k ( r ( x ) + f - \sqrt{{x}^{2} + {f}^{2}} ) ] ⅆ x & ( 3 ) \\ Where ω = \frac{2 m π}{period} & ( 4 )\end{matrix}$$

Let

β(x)=k(r(x)+f−\sqrt{^{x}²+f²}) (5)

$$\begin{matrix}{a}_{p} \int \frac{exp [ - ⅈω x ]}{r ( x )} exp [ ⅈ β ( x ) ] ⅆ x & ( 6 ) \\ = \int [ cos ( ω x ) - ⅈ sin ( ω x ) ] \frac{1}{r ( x )} [ cos ( β ( x ) ) + ⅈ sin ( β ( x ) ) ] ⅆ x & ( 7 )\end{matrix}$$

We are only interested in the real part of this expression because the CGH is typically an amplitude modulator. The real part of the integral then becomes:

$$a \int \frac{1}{r ( x )} [ cos ( ω x ) cos ( β ( x ) ) + sin ( ω x ) sin ( β ( x ) ) ] ⅆ x \qquad ( 8 )$$

This integral can be evaluated using Simpson's Rule.

Alternatively, a more computationally efficient method is to evaluate the integral using a FFT technique. In this case then we need an integral of the form:

∫exp[iωx]h(x)dx

or equivalently

I_{Real}=∫cos(ωx)h(x)dx

I_{Imag}=∫sin(ωx)h(x)dx

And so we re-arrange (8) to give:

$$\begin{matrix}a \int cos ( ω x ) h ( x ) ⅆ x \\ where h ( x ) = \frac{1}{r ( x )} [ cos ( β ( x ) ) + \frac{sin ( ω x ) sin ( β ( x ) )}{cos ( ω x )} ]\end{matrix} \qquad ( 9 )$$

Another FFT based technique involves re-arranging (7) to form FFT pairs that can be evaluated and the results re-arranged appropriately. This is shown below. Equation (7) can be re-arranged as:

$$\begin{matrix}a \int \frac{1}{r ( x )} cos ( ω x ) cos ( β ( x ) ) ⅆ x + a \int \frac{1}{r ( x )} sin ( ω x ) sin ( β ( x ) ) ⅆ x + \\ a I \int \frac{1}{r ( x )} cos ( ω x ) sin ( β ( x ) ) ⅆ x - a I \int \frac{1}{r ( x )} sin ( ω x ) cos ( β ( x ) ) ⅆ x\end{matrix} \qquad ( 10 )$$

These 4 integrals can be arranged into 2 FFT pairs. The result of a FFT integral is a real and imaginary part that can be used independently. So we write:

$$\begin{matrix}\begin{matrix}a \int \frac{1}{r ( x )} cos ( ω x ) cos ( β ( x ) ) ⅆ x - a I \int \frac{1}{r ( x )} sin ( ω x ) cos ( β ( x ) ) ⅆ x + \\ a \int \frac{1}{r ( x )} sin ( ω x ) sin ( β ( x ) ) ⅆ x + a I \int \frac{1}{r ( x )} cos ( ω x ) sin ( β ( x ) ) ⅆ x \end{matrix} & ( 11 ) \\ \begin{matrix}\int exp ( ω x ) h ( x ) ⅆ x where h ( x ) = a \frac{1}{r ( x )} cos ( β ( x ) ) \\ \int exp ( ω x ) h ( x ) ⅆ x where h ( x ) = a \frac{1}{r ( x )} sin ( β ( x ) )\end{matrix} & ( 11 a , 11 b )\end{matrix}$$

The final result can be achieved by firstly negating the sin part of (11a), and secondly adding the real part and imaginary part of (11a) and (11b) together in order to give the final result of (7). In practice, we need only evaluate the real components. This technique has been shown to agree perfectly with Simpson's Rule on the real and imaginary parts of (7) as shown in (8).

The result of these differing techniques is a hogel vector (HV). The information content and quality of the resultant point in image volume space may be manipulated by reducing the number of HV elements. The minimum number of HV elements required to adequately sample the DTP can be estimated by finding the maximum rate of change of the wavefront over the hogel. Using this value, any additional HV elements can be neglected.

The hogel vector can be decoded by an inverse Fourier transform.

This is the most direct and computationally efficient method. An alternatively strategy is to use basis fringes in the decoding step. This can still be done as an off-line calculation, and may have advantages in image quality manipulation and control.

The present invention has been implemented in software using the following basic routine, shown here in top level in pseudo code:

```
For each line of the hologram:
  For each hogel along the line:
    Reset hogel fringe buffer to zeros
    Open the appropriate Multiple Viewpoint Renderer intensity and
                    depth files
    For each hogel lateral resolution position:
      Read corresponding Multiple Viewpoint Renderer image
                  pixel depth
      Find corresponding DTP with nearest depth to image
                    depth
      Read corresponding Multiple Viewpoint Renderer image
                  pixel intensity
      For each DTP pixel:
        Read pixel amplitude.
        Multiply DTP pixel amplitude by rendered image
                  pixel intensity
        Accumulate result into hogel fringe buffer.
      Next DTP pixel
    Next hogel lateral position
    Output hogel fringe
  Next Hogel
Next hologram line
Output hologram
```

The current invention has been implemented on an Active-Tiling® Computer Generated Hologram display system. The computer system used to produce the CGH can be a standalone unit, or could have remote elements connected by a network.

The Active Tiling system is a means of producing holographic moving images by rapidly replaying different frames of a holographic animation. The Active Tiling system essentially comprises a system for directing light from a light source onto a first spatial light modulator (SLM) means and relaying a number of SLM subframes of the modulated light from the first high speed SLM means onto a second spatially complex SLM. The CGH is projected from this second SLM.

The full CGH pattern is split up into subframes in which the number of pixels is equal to the complexity of the first SLM. These frames are displayed time-sequentially on the first SLM and each frame is projected to a different part of the second SLM. The full image is thus built up on the second SLM over time. The first SLM means comprises an array of the first SLMs that each tile individual subframes on the second SLM over their respective areas.

Light from an SLM in the array must not stray onto parts of the second SLM not intended for it. To prevent this a shutter can be placed between the first SLM means and the second SLM, which masks off those areas of the second SLM that are not currently being written to. Alternatively, electrodes on the second SLM that cover the area where it is not wished to write an image can simply be not provided with a drive voltage. Thus any light that is falling onto the second SLM in these areas has no effect on the modulation layer. This avoids the need for a shutter system. The first SLM of such a system is of a type in which the modulation pattern can be changed quickly, compared to that of the second SLM. Thus its updating frame rate is greater than the read-out frame rate of the second SLM.

The Active Tiling system has the benefit that the image produced at the second SLM, which is addressed at a rate much slower than that of the first SLM array, is effectively governed by the operation of the first SLM. This permits a trade off between the temporal information available in the high frame rate SLMs used in the SLM array and the high spatial resolution that can be achieved using current optically addressed SLMs as the second SLM. In this way, a high spatial resolution image can be rapidly written to an SLM using a sequence of lower resolution images.

See PCT/GB98/03097 for a full explanation of the Active Tiling system.

### REFERENCES

1“Diffraction specific fringe computation for electro-holography”, M Lucente, Doctoral thesis dissertation, MIT Department of Electrical Engineering and Computer Science, September 1994.

2. “Computational holographic bandwidth compression”, M Lucente, IBM Systems Journal, October 1996.

3. Holographic bandwidth compression using spatial sub sampling, M Lucente, Optical Engineering, June 1996.

4. Patent application, Aberration Control of Images from Computer Generated Holograms—PCT/GB00/01 898

1. A computer generated hologram display system comprising at least a light diffraction plane notionally divided into a plurality of hogels, an image volume space and image calculation means, wherein the image calculation means incorporates a diffraction table that stores, for each hogel, fringe information that can be written to the hogel that directly reconstructs a wavefront to be projected towards the image volume space to create an image point.

2. A computer generated hologram display system as claimed in claim 1, wherein the fringes stored in the diffraction table are computed before any element of the image has been displayed.

3. A computer generated hologram display system as claimed in claim 1 or claim 2 wherein a hogel vector associated with a particular hogel is calculated by Fourier transforming the real component of a calculated wavefront projected from a point to be displayed to the hogel.

4. A computer generated hologram display system as claimed in claim 3 wherein a hogel fringe to be written to the hogel is produced by transforming the hogel vector to the spatial domain.

5. A computer generated hologram display system as claimed in any of the above claims wherein the image calculation means is arranged to calculate a plurality of image points that together make up an image having full parallax

6. A computer generated hologram display system as claimed in claims 1 to 4 wherein the image calculation means is arranged to calculate a plurality of image points that together make up an image having horizontal parallax only

7. A method for displaying a computer generated hologram display system comprising at least a light diffraction plane notionally divided into a plurality of hogels, an image volume space and image calculation means, wherein the method comprises the steps of incorporating a diffraction table with the image calculation means and storing in the diffraction table pre-calculated fringe information for each hogel, and writing the fringe information to each hogel that directly reconstructs a wavefront to be projected towards the image volume space to create an image point.

8. A method as claimed in claim 7 wherein the image calculation means looks up the appropriate diffraction table entry for a given hogel based on information derived from the geometry of an object to be displayed.

9. A computer generated hologram display system as claimed in claim 1 wherein the display system comprises:
a light source,
a first spatial light modulator means having an associated updating frame rate, that modulates light from the light source,
relay optics means in the path of the light from the first spatial light modulator means for guiding the modulated light therefrom,
a second spatial light modulator having an associated read-out frame rate in the path of the guided light from the relay optics means and arranged to produce a real image therefrom for display,
wherein the updating rate of the first spatial light modulator means is greater than the read-out frame rate of the second spatial light modulator means.

10. A computer program capable of representing a three dimensional object using the method as claimed in claim 7 or claim 8.

11. A carrier including a computer program as claimed in claim 10.

12. A computer generated hologram display system substantially as described herein with reference to FIGS. 6 and 7.

13. A method for displaying a computer generated hologram substantially as described herein with reference to FIGS. 6 and 7.
